(19) United States
(12) Patent Application Publication
(10) Pub. No.: US 2026/0129231 A1
(43) Pub. Date: May 7, 2026

(54) VIEWPORT AND/OR REGION-OF-INTEREST DEPENDENT DELIVERY OF V3C DATA USING RTP

(71) Applicant: InterDigital VC Holdings, Inc., Wilmington, DE (US)

(72) Inventors: Ahmed Hamza, Coquitlam (CA); Srinivas Gudumasu, Montreal (CA)

(73) Assignee: InterDigital VC Holdings, Inc., Wilmington, DE (US)

(21) Appl. No.: 19/117,626

(22) PCT Filed: Oct. 13, 2023
(86) PCT No.: PCT/US2023/035096

§ 371 Date: Apr. 1, 2025

Related U.S. Application Data
(60) Provisional application No. 63/415,893, filed on Oct. 13, 2022.
(60) Provisional application No. 63/539,958, filed on Sep. 22, 2023.

(51) Int. Cl. H04N 19/597; G06T 7/70; G06T 7/80; H04L 65/1104; H04L 65/65; H04N 21/6437

(52) U.S. Cl. CPC H04N 19/597; G06T 7/70; G06T 7/80; H04L 65/1104; H04L 65/65; H04N 21/6437

(57) ABSTRACT

Viewport- and/or region-of-interest-dependent delivery of V3C data may be performed using RTF, RTP/RTCP signaling may support spatial region based and/or viewport-based partial access of V3C content. An SDP parameter may signal static 3D regions In immersive media content. An RTCP FB message type may carry 3D region of interest request during an RTP media transmission session. An SDP parameter may indicate an RTCP-based ability to request a desired 3D region during capability negotiations. An RTP header extension type may carry transmitted 3D regions information during RTP transmission of immersive media. An SDP parameter may indicate an RTP-based ability to signal transmitted 3D region information during capability negotiations. An SDP parameter may indicate an RTP-based ability to signal updated 3D region information during capability negotiations. An RTCP FB message type may carry viewport information during an RTP media transmission session. An SDP parameter may indicate RTCP-based capability to signal viewport information during capability negotiations.

### CROSS REFERENCE

This application claims the benefit of U.S. Provisional Application No. 63/415,893, filed on Oct. 13, 2022 and U.S. Provisional Application No. 63/539,958, filed on Sep. 22, 2023, the contents of which are incorporated by reference herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are described herein for performing viewport- and/or region-of-interest-dependent delivery of visual volumetric video-based coding (V3C) data, for example, using a real-time transport protocol (RTP). RTP/real-time control protocol (RTCP) signaling mechanisms may be used to enable support for spatial region based and/or viewport-based partial access of V3C content. A session description protocol (SDP) parameter may be used to signal static 3D regions present in immersive media content. An RTCP feedback (FB) message type may carry a desired 3D region of interest request, for example, during an RTP media transmission of a session. The RTCP FB message may be signaled from the receiver to the sender. An SDP parameter may indicate the RTCP-based ability to request the desired 3D region, for example, during capability negotiations. An RTP header extension type may carry transmitted 3D regions information during the RTP transmission of immersive media. An RTP header extension type may be signaled from the sender to the receiver.

Capability negotiations may be performed between a sender and a receiver of V3C content. An SDP parameter may indicate an RTP-based capability to signal transmitted 3D region information, for example, during the capability negotiations. An SDP parameter may indicate an RTP-based capability to signal updated 3D region information, for example, during capability negotiations. An RTCP FB message type may carry desired and/or requested viewport information, for example, during an RTP media transmission of a session. An RTCP FB message type may be signaled from the receiver to the sender. An SDP parameter may indicate an RTCP-based capability to signal desired and/or requested viewport information, for example, during capability negotiations.

A device may be configured to receive a set of session description protocol (SDP) parameters indicating presence of one or more 3D regions associated with immersive content. The device may send a real-time control protocol (RTCP) feedback (FB) message indicating a three-dimensional (3D) region of interest and/or a 3D viewport of interest. The device may receive one or more 3D regions of visual volumetric video-based coding (V3C) content associated with the interested 3D region and/or the 3D viewport of interest.

The device may perform capability negotiations (e.g., using SDP). The set of SDP parameters may be received during the capability negotiations.

The set of received 3D regions information may be received using a real time protocol (RTP) header extensions and the use of RTP header extensions may be signaled in an SDP message.

In examples, the interested 3D region may be a static 3D region and/or an arbitrary 3D region. The RTCP FB message may include an indication of a region ID associated with the interested 3D region, an indication of a position associated with the interested 3D region, and/or a size associated with the interested 3D region.

The RTCP FB message may indicate whether extrinsic camera parameters are present in the RTCP message, whether intrinsic camera parameters are present in the RTCP message, and/or whether a horizontal FOV associated with the 3D viewport of interest and a vertical FOV associated with the 3D viewport of interest are equal.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a system in which various aspects and examples may be implemented.

FIG. 5 illustrates an example spatial subdivision of a point cloud.

### DETAILED DESCRIPTION

A more detailed understanding may be had from the following description, given by way of example in conjunction with the accompanying drawings.

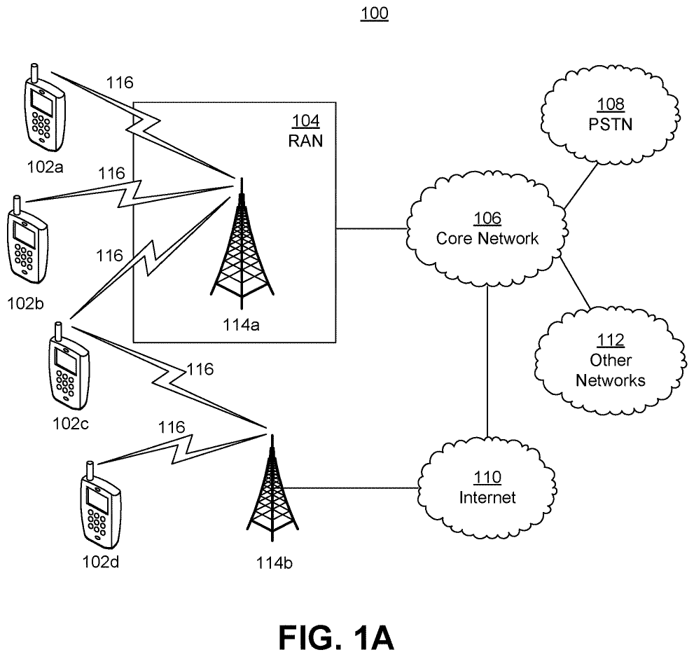

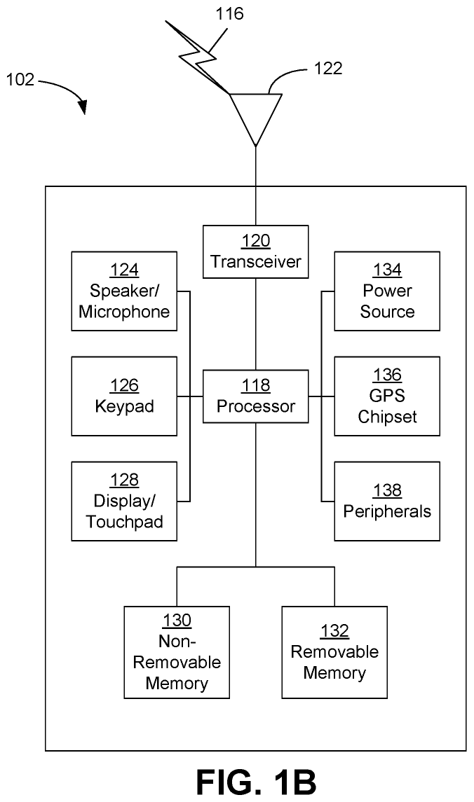

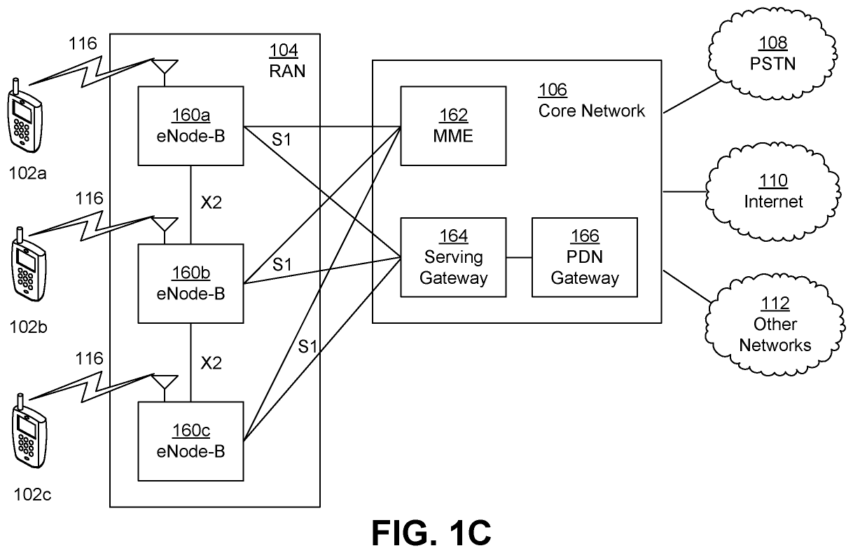

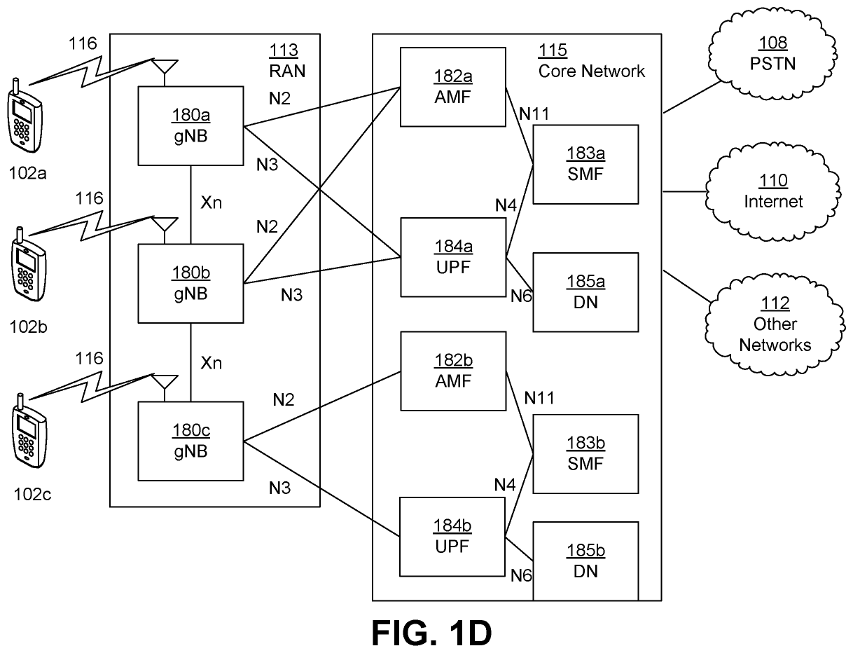

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b. 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b. 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a. 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a. 180b, 180c and one or more eNode-Bs 160a, 160b, 160c substantially simultaneously. In the non-standalone configuration, eNode-Bs 160a, 160b. 160c may serve as a mobility anchor for WTRUs 102a, 102b. 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a. 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b. 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c. AMF 182a-b, UPF 184a-b, SMF 183a-b. DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

The aspects described and contemplated in this application may be implemented in many different forms. FIGS. 1-4 described herein may provide some examples, but other examples are contemplated. The discussion of FIGS. 1-4 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

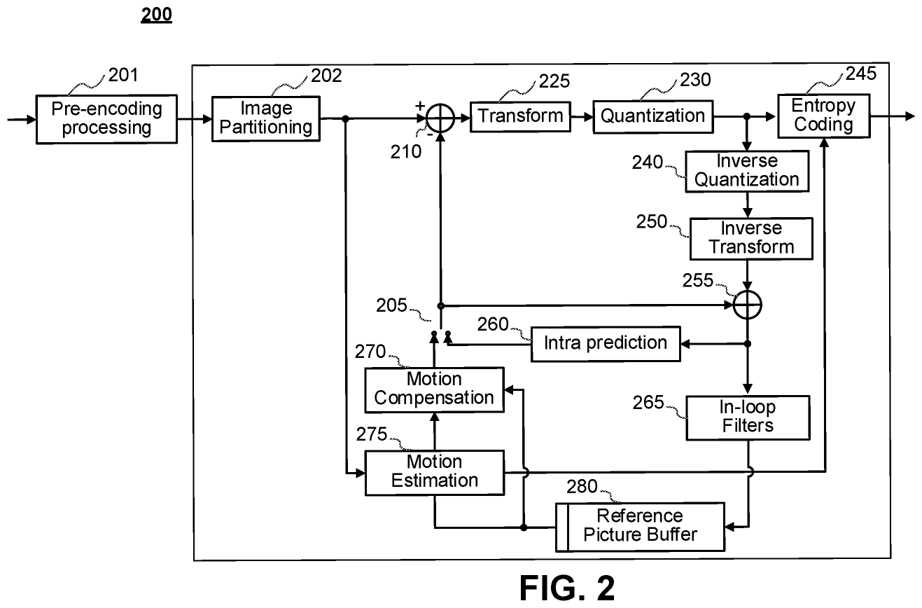

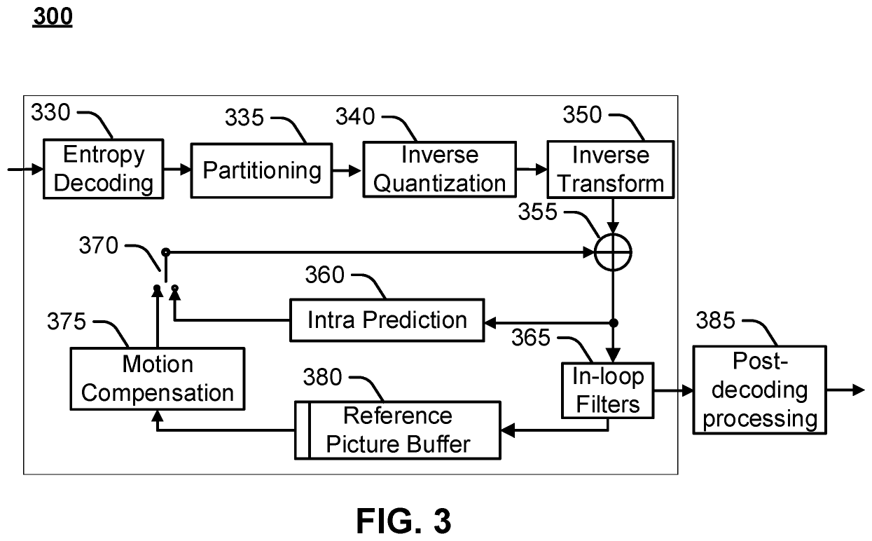

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application, such as bit positions, the number of bits, the number of bytes, the number of fields, parameter values, parameter value ranges, the number of packets, packet positions, 3D region IDs, coordinates, etc. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, such as picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filter) filtering to reduce encoding artifacts. The filtered image is stored in a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380). In some examples, for a given picture, the contents of the reference picture buffer 380 on the decoder 300 side may be identical to the contents of the reference picture buffer 280 on the encoder 200 side (e.g., for the same picture).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

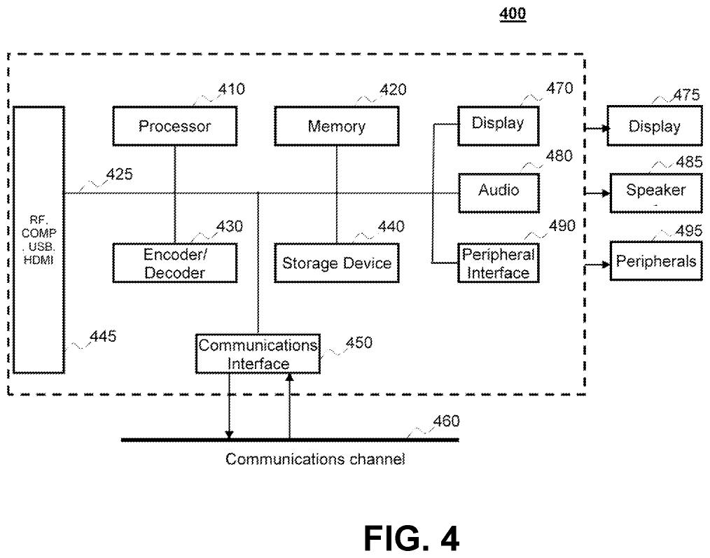

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, coding syntax that may be used to signal one or more of the following and/or information associated with one or more of the following: an SDP parameter that indicates at least one static 3D region in the V3C content; an RTCP FB message type that indicates a 3D region of interest; an SDP parameter that indicates the RTCP-based ability to request the desired 3D region; an RTP header extension type that indicates transmitted 3D region information; an SDP parameter that indicates an RTP-based capability to signal transmitted 3D region information; an RTCP FB message type that indicates desired or requested viewport information; and/or an SDP parameter that indicates an RTCP-based capability to signal desired or requested viewport information, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, one or more of the following: an SDP parameter that indicates at least one static 3D region in the V3C content; an RTCP FB message type that indicates a 3D region of interest; an SDP parameter that indicates the RTCP-based ability to request the desired 3D region; an RTP header extension type that indicates transmitted 3D region information; an SDP parameter that indicates an RTP-based capability to signal transmitted 3D region information; an RTCP FB message type that indicates desired or requested viewport information; and/or an SDP parameter that indicates an RTCP-based capability to signal desired or requested viewport information, etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g., using a monitor, screen, or other type of display) a resulting image (e.g., an image from residual reconstruction of the video bitstream). The TV, set-top box, cell phone, tablet, or other electronic device may receive a signal including an encoded image and perform decoding.

3D point clouds (for example, high-quality 3D point clouds) may provide an advanced representation of immersive media. A point cloud may include a set of points represented in 3D space by coordinates indicating the location of each point, which may be associated with or accompanied by one or more attributes, such as a color associated with each point, transparency, time of acquisition, reflectance of laser or material property, etc. Point clouds may be captured, for example, in one or more (e.g., several) ways. For example, a point cloud may be captured by (e.g., using) multiple cameras and/or depth sensors. Light Detection and Ranging (LIDAR) laser scanners may (e.g., also) be used for capturing point clouds. The number of points utilized to reconstruct (for example, realistically reconstruct) objects and/or scenes using point clouds may be in the order of millions or billions of points. Efficient representation and compression may be used for storing and transmitting point cloud data.

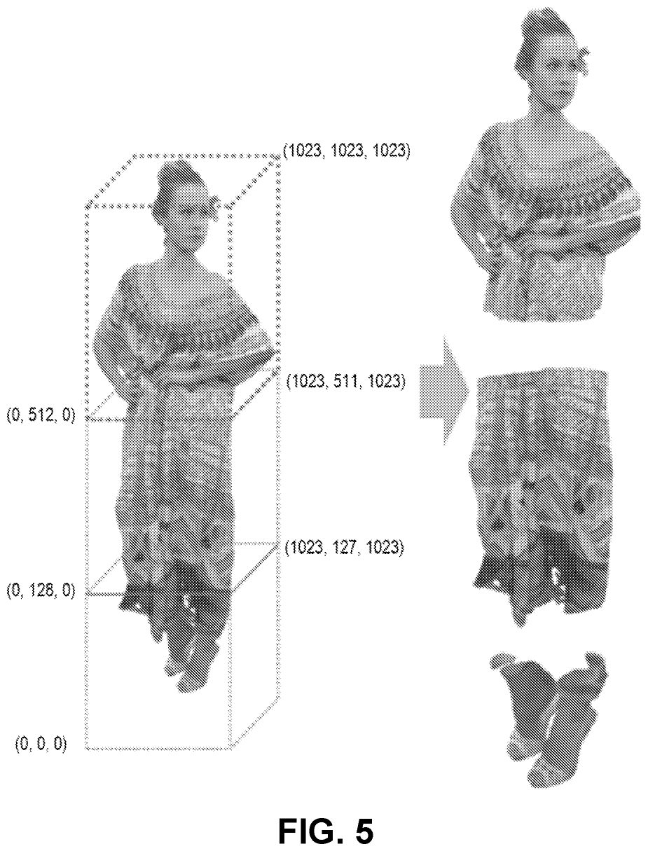

FIG. 5 illustrates an example subdivision of a point cloud.

Volumetric videos (for example, in uncompressed form) may be represented by a large amount of data. Visual Volumetric Video-based Coding (V3C) may utilize the compression efficiency of 2D video codecs to reduce the amount of data for storage and transmission of volumetric videos. A V3C encoder may convert volumetric frames into a collection of 2D image sequences and associated metadata, which may enable the reconstruction of the volumetric frames, referred to as atlas data. The resulting 2D image sequences may be coded using video or image encoders, such as advanced video coding (AVC), high efficiency video coding (HEVC), or versatile video coding (VVC). Atlas data may be coded, for example, using one or more mechanisms. V3C is a mechanism for volumetric video coding. V3C may be used by different applications targeting volumetric content compression, such as point clouds, immersive videos, and/or mesh representations of visual volumetric frames. Examples of such applications may include Video-based Point Cloud Compression (V-PCC) and MPEG Immersive Video (MIV).

V3C may utilize a high-level syntax (HLS) syntax, which may also be used in 2D video codecs, to represent the coded atlas data. Coded atlas data may be represented by Network Abstraction Layer (NAL) units, for example, a sequence of NALUs.

Real-time transport protocol (RTP) payload formats (for example, for V3C Atlas data) may be defined/configured for network abstraction layer (NAL)-unit-based 2D video codecs, such as H.264/AVC and HEVC.

A session description protocol (SDP) may be used to represent information associated with real time multimedia and/or communication sessions. Media capability details, transport addresses, and/or other media description metadata may be exchanged between participants as part of a session negotiation process, for example, when initiating multimedia teleconferencing, voice-over-IP calls, video streaming, and/or other real-time communication sessions. SDP may provide a representation for the information, irrespective of how the information is transported. SDP may be a format for session description. SDP may not incorporate a transport protocol.

An SDP description may include a session-level description section followed by zero or more media descriptions. A session-level section may start with a “v=” line and may continue to the first media description or the end of the whole description, for example, whichever comes first. A (for example, each) media description may start with an “m=” line and may continue to the next media description or the end of the whole session description, for example, whichever comes first. Session-level values may be a default for media present in a session, for example, unless overridden by an equivalent media-level value.

SDP may be extended, for example, using attributes. Attributes may be (for example, defined/configured to be) used as one or more of session-level attributes, media-level attributes, etc. A media description may include zero or more (for example, any number of) “a=” lines (attribute-fields), which may be media-description-specific and/or may be referred to as media-level attributes that add information about the media description.

A real-time transport protocol (RTP) may provide end-to-end network transport functions for applications transmitting real-time data, such as audio, video, and/or simulation data, over multicast or unicast network services. RTP may not address resource reservation. RTP may not guarantee quality-of-service for real-time services. Data transport may be augmented by a real-time control protocol (RTCP), for example, to enable monitoring of data delivery in a manner that is scalable to large multicast networks, and/or to provide minimal control and identification functionality. RTP and/or RTCP may be independent of the underlying transport and network layers.

An RTP protocol may support the use of RTP-level translators and mixers. An RTP protocol may provide end-to-end delivery services for data with real-time characteristics, such as interactive audio and video. Services may include, for example, one or more of the following: payload type identification, sequence numbering, timestamping, and/or delivery monitoring.

An RTP protocol may have header fields (e.g., fixed header fields). An RTP packet may include an RTP header (for example, a fixed RTP header), a list of contributing sources, which may be empty, and a payload. A control packet (for example, referred to as an RTCP packet) may include a header (for example, a fixed header), which may be accompanied by (for example, followed by) structured elements that vary, for example, depending on the RTCP packet type. An RTP payload may include data transported by an RTP in a packet, such as audio samples and/or compressed video data.

Table 1 shows an example of an RTP header format.

TABLE 1
Example of an RTP header format

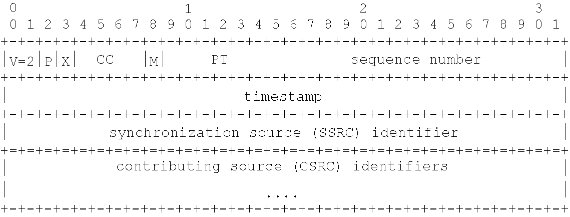

In some examples, the first twelve octets may be present in every RTP packet. The list of contributing source (CSRC) identifiers may be present, for example, if/when (for example, only if/when) inserted by a mixer. The semantics of the fields in an RTP header may be specified/configured. The fixed header may be followed by one or more header extensions, for example, if the extension bit is set.

An RTP header extension mechanism may support (for example, implementations with experimental) payload-format-independent functions that may be associated with (for example, additional) information carried in the RTP data packet header. An RTP header extension mechanism may be implemented, for example, so that the header extension may not be observed (for example, may be ignored) by other interoperating implementations that have not been extended. In an example, a variable-length header extension may be appended to an RTP header (for example, following the CSRC list, if present), for example, if the X bit in the RTP header is set to one. Table 2 shows an example of a header extension.

TABLE 2
Example of a header extension

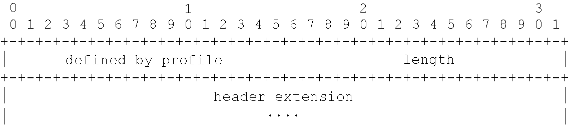

An RTP header extension may be formed as a sequence of extension elements, for example, with or without padding. An extension element (for example, each extension element) may have a local identifier and a length. The local identifiers may be mapped to a larger namespace in a negotiation, such as session signaling. An RTP header extension may be present (for example, may only be present) in a packet, for example, if the packet also includes one or more extension elements (for example, as described herein). An extension element may be present in a packet, for example, if/when needed. The signaling setup of extension elements may indicate that the elements (for example, only the signaled elements) may be re-sent in some packets, for example, as opposed to indicating that the elements are in fact present in one or more packets (for example, all or any packets).

An extension element (for example, each extension element) in a packet may have a local identifier (ID) and a length. One or more local identifiers present in a stream may have been negotiated or defined out-of-band. In some examples, there may not be static allocations of local identifiers. A (for example, each) distinct extension may have a unique ID. A value (for example, the value zero (0)) may be reserved for padding and/or may not be used as a local identifier. In some examples, there may be multiple (for example, two) variants of the extension, such as one-byte and two-byte headers.

A sequence of extension elements (for example, with or without padding) may form a header extension defined in an RTP specification. There may be as many extension elements as may fit into the length indicated in an RTP header extension length. A length may be signaled in full 32-bit words. Padding bytes may be used to pad to a boundary (for example, a 32-bit boundary). An extension (for example, an entire extension) may be parsed byte-by-byte, for example, to find an (for example, each) extension element (for example, with or without alignment). Parsing may stop at the earlier of the end of a header extension (for example, an entire header extension or in one-byte headers) or based on encountering an identifier with a reserved value (for example, a reserved value of 15). Padding bytes may have the same value (for example, the value of zero (0), for example, regardless how parsing ends. Padding bytes may be placed between extension elements (for example, for alignment) and/or after the last extension element, for example, if needed for padding.

A header extension may be one byte. A value for a header extension (for example, a 16-bit value for an RTP header extension) may have a fixed bit pattern (e.g., 0xBEDE).

A (for example, each) extension element may start with a byte including an ID and a length. Table 3 shows an example of a starting byte for an extension element.

TABLE 3
Example of a starting byte for an extension element

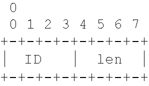

As shown by example in Table 3, a 4-bit ID may be a local identifier of the extension element, which may have a range of 1-14, inclusive, which may be referred to as the valid range (for example, for signaling). The local identifier value 15 may be reserved for future extension (for example, rather than being used as an identifier).

The 4-bit length may be the number of data bytes minus one byte for the header extension element following the one-byte header. The value zero in the field may indicate that one byte of data follows while a value of 15 (for example, the maximum) may indicate element data of 16 bytes. Table 4 shows an example header extension, with three extension elements, padding, and other RTP fields.

TABLE 4
Example of a header extension

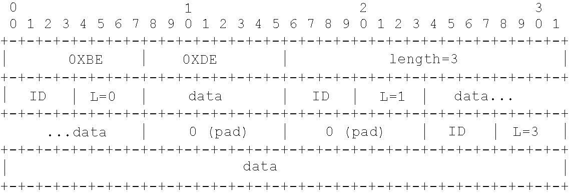

A header extension may be two bytes. Table 5 shows an example of a value of a header extension (for example, a 16-bit value for an RTP header extension).

TABLE 5
Example of a value of a header extension

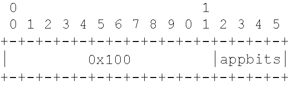

As shown by example in Table 5, the ‘appbits’ field may be 4 bits, which may be application-dependent and/or may be defined to have any value or meaning.

An extension element (for example, each extension element) may start with a byte including an ID and a byte including a length. Table 6 shows an example of an extension element.

TABLE 6
Example of an extension element

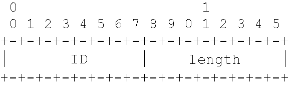

As shown by example in Table 6, the 8-bit ID may be the local identifier of the element, which may have a range of 1-255, inclusive. The range 1-256 may be referred to as a valid range, with the values 1-255 referring to extension elements, and the value 256 referring to the 4-bit field ‘appbits’ (for example, as shown above).

As shown by example in Table 6, the 8-bit length field may be the length of extension data in bytes, for example, not including the ID and length fields. The value zero (0) may indicate that there is no data following.

Table 7 shows an example of a header extension, with three extension elements, padding, and RTP fields.

TABLE 7
Example of a header extension

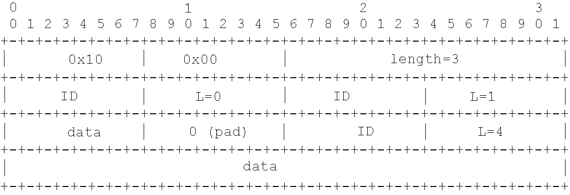

A (for example, each) local identifier used in a stream may be mapped to a string using an attribute, for example, having the following form:
a=extmap:<value>[“/”<direction>] <URI> <extensionattributes>
   The term <URI> may be a URI. The term <value> may be the local identifier (ID) of the extension, which may be an integer in the valid range inclusive. For example, the value zero (0) may be reserved for padding in both forms. The value 15 may be reserved in the one-byte header form, for example, as described herein. The term <direction> may be indicated by one of “sendonly,” “recvonly,” “sendrecv,” or “inactive.”

A real-time transport control protocol (RTCP) may be implemented. Real-time media streams that use RTP may be (for example, to some degree) resilient against packet losses. Receivers may use the base mechanisms of RTCP to report packet reception statistics, which may allow a sender to adapt its transmission behavior in the mid-term. RTCP may provide a means (for example, a sole means) for feedback and/or feedback-based error repair (for example, besides codec-specific mechanisms). An extension may be provided to an Audio-visual Profile (AVP) that enables receivers to provide (for example, statistically) more immediate feedback to the senders, which may allow for short-term adaptation and/or efficient feedback-based repair mechanisms to be implemented.

A payload format-specific SDP attribute may be defined/configured to indicate the capability of using RTCP feedback (for example: “a=rtcp-fb”). The “rtcp-fb” attribute may be used (for example, only) as an SDP media attribute and/or may not be provided at the session level. The “rtcp-fb” attribute may (for example, only) be used in media sessions for which the “AVPF” is specified. The “rtcp-fb” attribute may be used to indicate which RTCP FB messages may be used in a media session for the indicated payload type. A wildcard payload type (“*”) may be used to indicate that the RTCP feedback attribute applies to all payload types. Several “a=rtcp-fb” lines may be used, for example, if several types of feedback are supported and/or if the same feedback is specified for a subset of the payload types.

Payload-specific FB messages may transport information that is specific to a certain payload type. Payload-specific FB messages may be generated and acted upon at the codec layer.

Feedback messages (for example, all feedback messages) may use a common packet format. Table 8 shows an example of a packet format for a feedback message.

TABLE 8
Example of a packet format for a feedback message

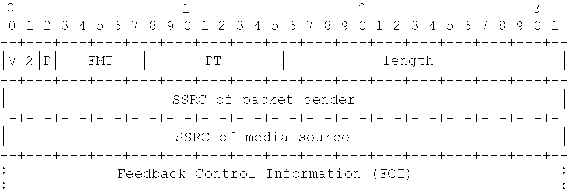

As shown by example in Table 8, the fields V, P, SSRC, and length may be defined in an RTP configuration. For example, version (V) may be two (2) bits. The field V may identify the RTP version (for example, version 2). Padding (P) may be one (1) bit. Padding, if set, may indicate that the packet includes additional padding octets at the end that are not part of the control information, but are included in the length field. Feedback message type (FMT) may be, for example, five (5) bits. The FMT field may identify the type of the FB message. The FMT field may be interpreted relative to the type (for example, transport layer, payload-specific, or application layer feedback). The values for each of the three feedback types may be configured. The payload type (PT) may be, for example, eight (8) bits. The PT field may be the RTCP packet type that identifies the packet as being an RTCP FB message. Table 9 shows an example definition of two values.

TABLE 9
Example definition of vales for the PT field

| Name | Value | Brief Description |
|---|---|---|
| RTPFB | 205 | Transport layer FB message |
| PSFB | 206 | Payload-specific FB message |

The length may be, for example, 16 bits. The length of the packet may be indicated in 32-bit words minus one, for example, including the header and any padding. This definition of length may be in line with the definition of the length field used in RTCP sender and receiver reports. The synchronization source (SSRC) of the packet sender may indicate the SSRC identifier of the originator of the packet. The SSRC of a packet sender may be, for example, 32 bits. The SSRC of the media source may indicate the synchronization source identifier of the media source that the piece of feedback information is related to. The SSRC of the media source may be, for example, 32 bits. Feedback Control Information (FCI) may have a variable length.

Technologies in capturing and rendering 3D points may enable novel applications in the areas of tele-presence, virtual reality, and/or large-scale dynamic 3D maps. 3D point cloud compression (PCC) may include geometry-based compression for static point clouds and video-based compression for dynamic point clouds. 3D PCC may support efficient and interoperable storage and transmission of 3D point clouds. 3D PCC may support lossy and/or lossless coding of point cloud geometry coordinates and attributes.

The transport and signaling of V3C data may be limited to delivery using dynamic adaptive streaming over HTTP (MPEG-DASH) and/or the MPEG Media transport (MMT) protocols. Real-time communication applications may utilize an RTP payload format for visual volumetric video-based coding.

An RTP payload format for visual volumetric video-based coding may specify how to transport the V3C data using the RTP protocol. An RTP payload format for visual volumetric video-based coding may specify partial access and delivery of V3C data, which may be utilized for viewport-dependent delivery. A portion of the point cloud data may be fetched from a sending device, for example, based on the user's current viewport onto a receiving device. Partial access support may be provided for the delivery of V3C data using the RTP protocol.

RTP/RTCP signaling mechanisms may be used to enable support for spatial region based and/or viewport-based partial access of V3C content. An SDP parameter may be used to signal static 3D regions present in immersive media content. An RTCP feedback (FB) message type may carry a desired 3D region of interest during the RTP transmission of media. The RTCP FB message may be signaled from the receiver to the sender. An SDP parameter may indicate the RTCP-based ability to request the desired 3D region, for example, during the capability negotiations. An RTP header extension type may carry transmitted 3D regions information during the RTP transmission of immersive media. The RTP header extension type may be signaled from the sender to the receiver. An SDP parameter may indicate the RTP-based ability to signal transmitted 3D region information, for example, during the capability negotiations. An SDP parameter may indicate the RTP-based ability to signal updated 3D region information, for example, during the capability negotiations. An RTCP feedback (FB) message type may carry desired and/or requested viewport information, for example, during the RTP transmission of media. The RTCP FB message type may be signaled from the receiver to the sender. An SDP parameter may indicate the RTCP-based ability to signal desired and/or requested viewport information, for example, during the capability negotiations.

Streaming may be 3D spatial region dependent streaming.

Static 3D regions may be signaled in SDP. RTP may be used to send volumetric media. The 3D regions present in a volumetric media object may be signaled using a session description protocol message and the desired 3D regions by a client may be signaled as an extension of a real-time transport control protocol message (for example, as defined in an RTP/AVPF codec control message).

A sender supporting a static 3D regions mode may offer static 3D regions information present in a volumetric media in the initial offer-answer negotiation, for example, by carrying it in the SDP message. For example, an attribute (e.g., an “a=3d-regions” attribute) may be included under the relevant media line. One or more of the following parameters may be provided in the attribute for a static 3D region (e.g., for each static 3D region): region_id; position_x; position_y; position_z; size_X; size_Y; size_Z; or name.

The parameter region_id may identify a pre-defined 3D region. The parameter position_x may specify the origin position of the 3D bounding box in the Cartesian coordinates along the x axis. The parameter position_y may specify the origin position of the 3D bounding box in the Cartesian coordinates along the y axis. The parameter position_z may specify the origin position of the 3D bounding box in the Cartesian coordinates along the z axis. The parameter size_X may specify the extension of the 3D bounding box of the volumetric media in the Cartesian coordinates along the x axis relative to the origin position. The parameter size_Y may specify the extension of the 3D bounding box of the volumetric media in the Cartesian coordinates along the y axis relative to the origin position. The parameter size_Z may specify the extension of the 3D bounding box of the volumetric media in the Cartesian coordinates along the z axis relative to the origin position. The parameter name may specify the name of the pre-defined 3D region.

The syntax for an “a=3d-regions” attribute may conform to the following augmented Backus-Naur form (ABNF):

```
  3d-regions = “3d-regions:” PT 1*WSP attr-list
  PT = 1*DIGIT / “*”
  attr-list = ( set *(1*WSP set) ) / “*”
    ; WSP and DIGIT defined
  set= “[” “region_id=” idvalue “,” “Position_X=” posvalue “,” “Position_Y=” posvalue “,”
“Position_Z=” posvalue “,” “Size_X=” sizevalue “,” “Size_Y=” sizevalue “,” “Size_Z=” sizevalue “,” “Name=”
namevalue “]”
  idvalue= onetonine*2DIGIT
    ; Digit between 1 and 9 that is
    ; followed by 0 to 2 other digits
  posvalue = sizevalue / “0”
    ; position may be “0”
  sizevalue = onetonine *5DIGIT
    ; Digit between 1 and 9 that is
    ; followed by 0 to 5 other digits
  onetonine = “1” / “2” / “3” / “4” / “5” / “6” / “7” / “8” / “9”
    ; Digit between 1 and 9
  namevalue = byte-string
    ; byte-string defined
```

An “a=3d-regions” attribute may be used relative to a media line, for example, as follows:

$$a = 3 d - regions : 99$$

$$[ region\_id = 0 , position\_x = 0 , position\_y = 0 , position\_z = 0 , size\_x = 540 , size\_y = 360 , size\_z = 360 , name = Head ]$$

$$[ region\_id = 1 , position\_x = 0 , position\_y = 360 , position\_z = 0 , size\_x = 1080 , size\_y = 360 , size\_z = 360 , name = Arms ]$$

$$[ region\_id = 2 , position\_x = 0 , position\_y = 720 , position\_z = 0 , size\_x = 540 , size\_y = 360 , size\_z = 360 , name = Body ]$$

$$[ region\_id = 3 , position\_x = 0 , position\_y = 1080 , position\_z = 0 , size\_x = 540 , size\_y = 360 , size\_z = 360 , name = Legs ]$$

RTCP feedback messages may include a request for a spatial region and the support for requesting a spatial region may be signaled in an SDP message. A client supporting 3D regions may support at least one mode to request a desired 3D region of interest, which may be signaled from a receiver to a sender. Modes may include, for example, static 3D regions and/or arbitrary spatial regions.

Requests may be provided/received for static 3D regions. A client supporting a static 3D regions mode may offer static 3D regions in SDP for (for example, all) volumetric media streams, for example, where static 3D regions capabilities are desired. Static 3D regions capabilities may be offered, for example, by including the a=rtcp-fb attribute with the static 3D regions type under the relevant media line scope. The static 3D regions type may be expressed (for example, in conjunction with the RTCP feedback method) with the following parameter: 3d-regions-static. A wildcard payload type (“*”) may be used to indicate that the RTCP feedback attribute for static 3D regions mode signaling applies to one or more (for example, all) payload types. Multiple (for example, several) “a=rtcp-fb” lines may be used, for example, if multiple (for example, several) types of 3D regions signaling are supported and/or if the same static 3D regions are specified for a subset of the payload types. An example usage of the a=rtcp-fb attribute to signal static 3D regions relative to a media line based on the RTCP feedback method may be as follows:

$$a = rtcp - fb {:}^{⋆} 3 d - regions - static$$

Requests may be provided/received for arbitrary spatial regions. A client that supports requests for arbitrary spatial regions may indicate this support in an SDP offer for (for example, all) volumetric media streams, for example, where arbitrary spatial regions request capabilities are desired. An indication may be provided, for example, by including the a=rtcp-fb attribute line within the scope of the relevant media line in the SDP message, for example, with a feedback message type corresponding to the arbitrary spatial regions mode. The RTCP feedback message type corresponding to the arbitrary spatial regions mode may be expressed with the parameter: spatial-region-arbitrary. A wildcard payload type (“*”) may be used to indicate that the RTCP feedback attribute for signaling arbitrary spatial regions requests applies to (for example, all) payload types. Multiple (for example, several) “a=rtcp-fb” lines may be used, for example, if the same arbitrary spatial regions are specified for a subset of the payload types. An example for the usage of the a=rtcp-fb attribute to signal support for requests for arbitrary spatial regions in an SDP message based on the RTCP feedback method may be as follows:

$$a = rtcp - fb {:}^{⋆} spatial - region - arbitrary$$

An SDP offer may include a set of offered static 3D regions, which may be provided using the “a=3d-regions” line(s). An RTP session endpoint accepting the static 3D regions request capabilities in the incoming SDP offer may respond by providing an SDP answer, for example, using the “a=3d-regions” line(s) including the accepted set of static 3D regions. An SDP answer may (for example, also) include the “a=rtcp-fb:*3d-regions-static” line. The accepted set of static 3d regions may be identical to the offered spatial 3D regions or a subset of the offered spatial 3D regions. In some examples, an SDP answer that includes the “a=rtcp-fb:*3d-regions-static” line, but does not include a “a=3d-regions” line may indicate that the client supports the static 3D regions mode and/or that the 3D regions in the offered set of static 3D regions are not acceptable for this client. The receiver may (for example, following the successful negotiation of static 3D regions) use the RTCP feedback method to request from the accepted set of static 3D regions. The sender may encode the sent immersive media accordingly to provide the requested static 3D regions.

The “a=3d-regions” lines may be ignored, for example, if the SDP offer provides the “a=3d-regions” but not “a=rtcp-fb:*3d-regions-static.”

A new SDP offer-answer negotiation may be performed to modify the set of static 3D regions. The sender may update (for example, all of) the content of static 3D regions, for example, including the total number of static 3D regions, and the position, size, and/or name of each of the 3D regions.

RTCP feedback messages may be used for requesting 3D regions-of-interest. 3D regions-of-interest request (or requests) may signal the current 3D region of interest of the immersive media on the receiver side to the sender for (for example, appropriate) encoding and transmission.

Requests for 3D regions of interest, whether the 3D regions available at the sender side are static or dynamic, may be signaled, for example, using RTCP feedback messages. An RTCP feedback message may be identified by a payload type (PT) (for example, PT equal to 206) that refers to a payload-specific feedback (PSFB) message. A feedback message type (FMT) may be set to a value (for example, the value 18) for 3D region of interest feedback messages. The RTCP feedback method may involve signaling 3D region-of-interest information in one or more modes, for example, both immediate feedback and early RTCP modes.

RTCP feedback messages may be used for a static 3D region request. An RTCP feedback message for requesting a 3D region-of-interest may include a region_id parameter, for example, if/when the 3D regions available at the sender-side are static. The value of region_id may be acquired from “a=3d-regions” attributes, which may be signaled during the SDP offer-answer negotiation. The value for the region_id parameter may be indicated, for example, using two bytes. Table 10a shows an example format for feedback control information (FCI) for an RTCP feedback message for a static 3D region request.

TABLE 10a
Example format for FCl for an RTCP feedback message

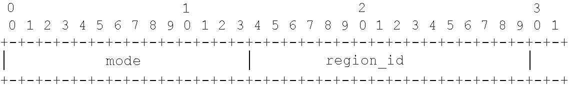

An RTCP feedback message from the receiver may conform to a message format for static 3D regions or arbitrary spatial regions, respectively, for example, if static 3D region and arbitrary spatial region capabilities are successfully negotiated. The sender may distinguish between the RTCP feedback message formats, for example, by parsing the first 16 bits associated with the mode field. The mode field may be set (e.g., uniquely set) to a value, for example, all ones in case of static 3d-regions requests.

An RTCP feedback message for requesting multiple 3D regions-of-interest may include a number of 3D regions and the list of required region_id parameters, for example, when the 3D regions available at the sender-side are static. The values of region_id may be acquired from the “a=3d-regions” attributes that are signaled during the SDP offer-answer negotiation. The value for num_regions and each region_id parameter may be indicated using a set of bytes (e.g., two bytes). Table 10b shows an example format for FCI for an RTCP feedback message for a static 3D region request.

Table 10b illustrates an example of the FCI for an RTCP feedback message for a static 3D region request may be in the format as

TABLE 10b
Example format for FCl for an RTCP feedback message for a static 3D region request

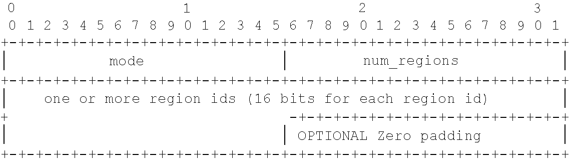

RTCP feedback messages may be used for an arbitrary spatial-region request. The FCI format for a 3D region-of-interest may be described herein. The FCI may include a (for example, exactly one) 3D region. The 3D region information may be composed of one or more of the following parameters: position_x, position_y, position_z, size_x, size_y, and/or size_z.

The parameter position_x may specify the origin position of the 3D bounding box in the Cartesian coordinates along the x axis. The parameter position_y may specify the origin position of the 3D bounding box in the Cartesian coordinates along the y axis. The parameter position_z may specify the origin position of the 3D bounding box in the Cartesian coordinates along the z axis. The parameter size_x may specify the extension of the 3D bounding box of the volumetric media in the Cartesian coordinates along the x axis relative to the origin position. The parameter size_y may specify the extension of the 3D bounding box of the volumetric media in the Cartesian coordinates along the y axis relative to the origin position. The parameter size_z may specify the extension of the 3D bounding box of the volumetric media in the Cartesian coordinates along the z axis relative to the origin position.

An RTCP feedback message for a 3D region-of-interest may include one or more of the parameters position_x, position_y, position_z, size_x, size_y, and/or size_z, for example, for arbitrary spatial region requests. The values for (for example, each of) the parameters may be indicated, for example, using four bytes. The sender may ignore 3D region-of-interest requests describing regions outside the original volumetric content. Table 11 shows an example format for the FCI for an RTCP feedback message for arbitrary spatial regions.

TABLE 11
Example format for the FCl for an RTCP feedback message for arbitrary spatial regions

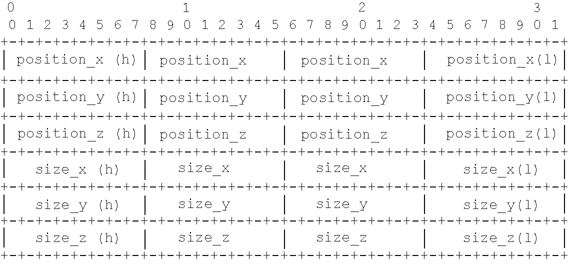

An indication (for example, for each four-byte indication) of the position_x, position_y, position_z, size_x, size_y, and/or size_z parameters may include a high byte (for example, indicated by ‘(h)’) may be followed by the low byte (for example, indicated by ‘(I)’), where the low byte holds the least significant bits.

3D spatial region dependent streaming may include signaling support for ‘Sent 3D Regions’ RTP header extension in SDP.

A client supporting ‘static 3D regions’ or ‘arbitrary spatial regions’ capabilities may (for example, also) include a ‘sent 3D regions signaling’ capability in its SDP offer for (for example, all) volumetric media streams. A receiver accepting ‘static 3D regions’ or ‘arbitrary spatial regions’ capabilities in an incoming SDP offer may (for example, also) accept an accompanying ‘sent 3D regions signaling’ offer. A sender accepting ‘static 3D regions’ or ‘arbitrary spatial regions’ capabilities may (for example, also) accept an accompanying ‘sent 3D regions’ signaling capability offer. The ‘sent 3D regions’ signaling capability may be offered, for example, by including the a=extmap attribute, which may indicate the ‘sent 3D regions’ URN under the relevant media line scope. The ‘sent 3D regions’ signaling URN corresponding to an arbitrary spatial regions may be urn: arbitrary-3d-regions-sent. The ‘sent 3D regions’ signaling URN corresponding to static 3D regions may be urn: static-3d-regions-sent. The URN may be used to signal transmitted 3D regions relative to a media line (e.g., the signaling may be part of the Atlas component media line), for example, as follows:

$$a = extmap : 8 urn : arbitrary - 3 d - regions - sent$$

$$a = extmap : 9 urn : static - 3 d - regions - sent$$

The numbers 8 and 9 in the example may be replaced with a number in the range 1-14, for example, if/when using a one-byte header extension mechanism. The numbers 8 and 9 in the example may be replaced with a number in the range 1-254, for example, if/when using a two-byte header extension mechanism.

3D spatial region dependent streaming may include an RTP header extension for signaling ‘sent 3D regions’.

A response to a request for 3D regions may involve the sender signaling the sent 3D regions, which may be included in the response, which may or may not agree with the 3D regions of interest requested by the receiver, but may include an extended or reduced version of the requested spatial region(s), for example, depending on the number and/or size of the 3D regions available in the content that overlap with the requested spatial region(s). The response may help the receiver determine if and/or when to send subsequent spatial region requests, for example, in response to head movement sensor information and/or based on the spatial volume covered by the 3D regions transmitted by the sender. Signaling the 3D regions sent by the sender may (for example, also) indicate the start of an RTP media flow belonging to a requested 3D region of interest.

A sender may signal a response, for example, if/when the ‘sent 3D regions; signaling capability is successfully negotiated.

An RTP header extension may be used to signal sent 3D regions for a static 3D region request.

The signaling of the sent 3D regions may be done using the RTP header extension, for example, if the sent 3D regions response (e.g., indicated via the URN urn:static-3d-regions-sent during SDP negotiation) corresponds to requests associated with one or more of the static 3D regions, the ‘sent 3D regions’ may be signaled using the RTP header extension. The signaling of the sent 3D regions (e.g., using the RTP header extension) may carry the num_regions and region_id parameters corresponding to the sent static 3d regions. The two-byte form of the header may be used. Table 12 shows an example two-byte header format to indicate the value for the num_regions and a list of region_id parameters using two bytes.

TABLE 12
Example two-byte header format to indicate the value for the num_regions
and a list of region_id parameters

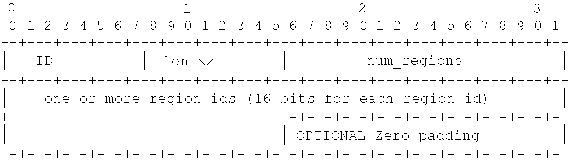

In the example shown in Table 12, the length field may take a value indicating the number of following bytes.

In some examples, a one-byte form of the header may be used to transmit the sent 3D regions information. Table 13 shows an example one-byte header format to indicate the value for the num_regions and a list of region_id parameters using two bytes.

TABLE 13
Example one-byte header format to indicate the value for the num_regions
and a list of region_id parameters

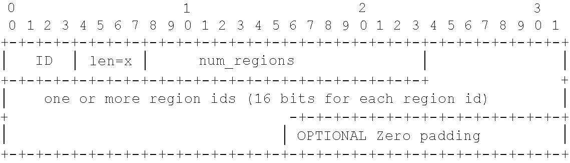

In the example shown in Table 13, the length field may take a value indicating the number of following bytes.

An RTP header extension may be used to signal a sent 3D regions response for an arbitrary spatial region request.

The signaling of the sent 3D regions may use RTP header extensions, for example, if the sent 3D region response (for example, which may be indicated via the URN urn:arbitrary-3d-regions-sent in the SDP negotiation) corresponds to an arbitrary spatial region request. The RTP header extension may carry the num_regions parameter, which may specify the number of spatial regions and/or information for each spatial region (spatial region information). A (for example, each) spatial region information may include, for example, one or more of the parameters position_x, position_y, position_z, size_x, size_y, size_z, region_id, num_tiles, and/or a list of tile identifiers associated with the spatial region. The two-byte form of the header should be used. The value for the parameters num_regions, num_tiles, region_id, an/or tile_id may be indicated, for example, using two bytes. Table 14 shows an example format to indicate (for example, each of) values for the parameters position_x, position_y, position_z, size_x, size_y, and/or size_z using four bytes.

TABLE 14
Example format to indicate parameter values using four bytes

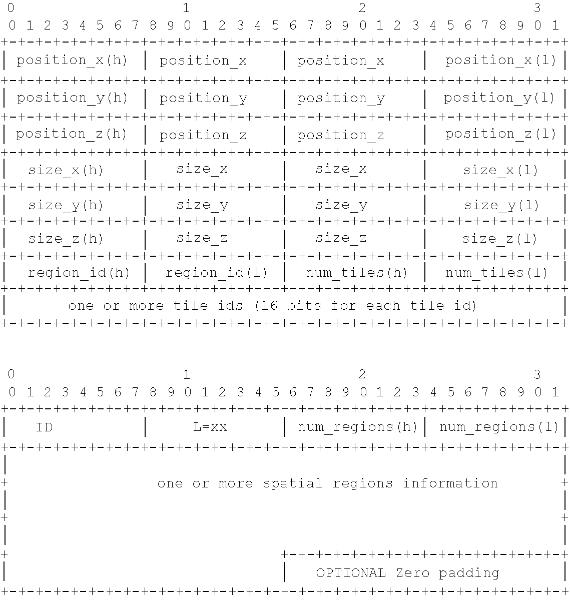

As shown by example in Table 14, the 8-bit ID may be the local identifier. The length field may indicate the number of following bytes. Each four-byte indication of the position_x, position_y, position_z, size_x, size_y and size_z parameters may include a high byte (for example, indicated by ‘(h)’) followed by low bytes (for example, indicated by ‘(l)’). Low bytes may hold the least significant bits and the high byte may hold the most significant bits. The num_regions, num_tiles, region_id, and/or tile_id parameters may (for example, each) be signaled using two bytes, where the high byte (for example, indicated by ‘(h)’) may be followed by the low byte (for example, indicated by ‘(l)’).

A requested 3D region-of-interest may be indicated as an arbitrary spatial region, for example, via the a=rtcp-fb:* spatial-region-arbitrary in the SDP negotiation. A sender may (for example, if the requested 3D region-of-interest is an arbitrary spatial region) choose to transmit one or more available spatial regions listed in the SDP corresponding to the requested arbitrary spatial region. The sent 3D regions may use the ‘static 3D regions sent’ RTP header extension and/or may carry the num_regions and region_id parameters corresponding to the static 3D regions that are sent by the sender in response to the receiver's request. The two-byte or one-byte form of the header may be used. Table 15 shows an example format with a two-byte header to indicate the values for the num_regions and region_id parameters using two bytes. Table 16 shows an example format with a one-byte header to indicate the values for the num_regions and region_id parameters using two bytes.

TABLE 15
Example format with a two-byte header to indicate the values for the num_regions
and region_id parameters using two bytes

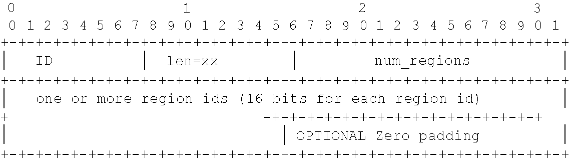

As shown by example in Table 15, the length field may take a value indicating the number of following bytes.

TABLE 16
Example format with a one-byte header to indicate the values for the num_regions
and region_id parameters using two bytes

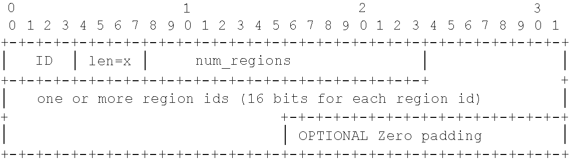

Arbitrary spatial regions and/or static 3D regions request features may be supported bi-directionally and/or uni-directionally, for example, depending on how clients negotiate to support the feature during SDP capability negotiations. In some examples, the ‘sendonly’ and/or ‘recvonly’ SDP attributes may be used, for example, for clients with asymmetric capability (e.g., an ability to process 3D regions information but not detect/signal 3D regions information). Clients may express their capability/capabilities in each direction (for example, sufficiently clearly) such that signals may be sent in each direction (for example, only) to the extent that they express useful information and/or may be processed by the recipient.

Support may be offered for ‘arbitrary spatial regions’ and/or ‘static 3D regions’ (for example, only one at a time or both at the same time, simultaneously or concurrently). The receiver may decide to request an arbitrary spatial region or a static 3D region at a given time, for example, if/when both capabilities are successfully negotiated by the sender and receiver. The sender may detect and/or track changes to the 3D regions, for example, if/when static 3D regions are offered by the sender.

3D spatial region dependent streaming may include dynamic 3D regions information.

A sender may send (for example, all) the dynamic 3D regions information to the receiver when the 3D regions are updated or changed, for example, if/when the 3D regions in an immersive media content are changing over time. This feature may be referred to as dynamic 3D regions support, which is different from the arbitrary spatial regions feature. A sender supporting dynamic 3D regions may initiate a sent 3D regions message, for example, if/when the spatial 3D regions configuration in an immersive media content changes over time. The message may not be sent in response to an RTCP feedback message received from a receiver. A sent 3D regions message for an arbitrary spatial region request may be a response from the sender to an RTCP feedback message received from the receiver.

SDP signaling may be used for sending dynamic 3D regions information. A sender supporting a ‘dynamic 3D regions’ capability may (for example, also) offer a ‘sent 3D regions signaling’ capability in an SDP message for volumetric media content. A receiver accepting the ‘dynamic 3D regions’ capability may (for example, also) accept an accompanying ‘sent 3D regions signaling’ capability in an offer. The ‘dynamic 3D regions’ capability may be offered, for example, by including the a=extmap attribute, which may indicate ‘sent 3D regions signaling’ URN, for example, under a relevant media line scope. A ‘sent 3D regions signaling’ URN corresponding to the dynamic 3D regions mode may be urn: dynamic-3d-regions-sent. The URN may be used to signal sent dynamic 3D regions relative to a media line, for example, as follows:

$$a = extmap : 10 urn : dynamic - 3 d - regions - sent$$

An RTP header extension may be used for sent dynamic 3D regions. An update of a 3D regions configuration may be signaled using an RTP header extension, for example, if/when the ‘sent 3D regions signaling’ mode corresponds to dynamic 3D regions, which may be indicated via the URN urn:dynamic-3d-regions-sent during SDP negotiation. An RTP header extension may carry the number of spatial regions and/or information for each spatial region (spatial region information). A (for example, each) spatial region information may include one or more of the parameters position_x, position_y, position_z, size_x, size_y, size_z, region_id, num_tiles, and/or a list of tile_ids associated with the spatial region(s). The two-byte form of the header may be used. The value for the parameter num_regions and/or num_tiles may be indicated, for example, using two bytes. The values for the parameters position_x, position_y, position_z, size_x, size_y, and/or size_z of each spatial region may be indicated, for example, using four bytes. The region_id and/or each tile_id may be indicated, for example, using two bytes.

Table 17 shows an example format for a sent 3D regions message in an RTP header extension. Table 18 shows an example format for each 3D region in a sent 3D regions (for example, as shown in Table 17).

TABLE 17
Example format for a sent 3D regions message in an RTP header extension

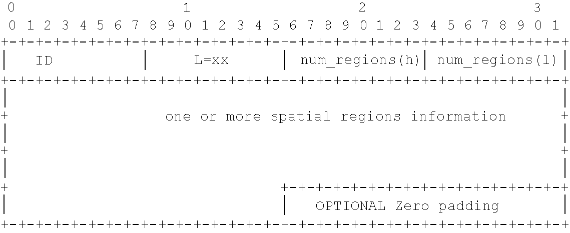

TABLE 18
Example format for each 3D region in a sent 3D regions

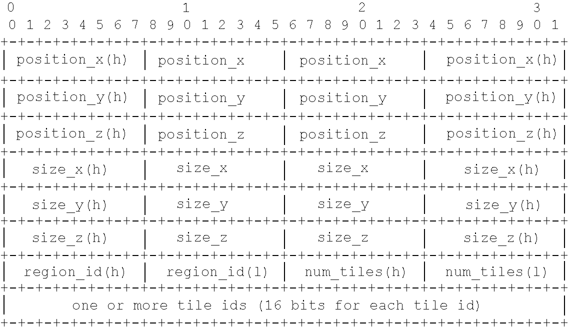

Information of (for example, all) updated spatial regions present in an immersive media content may be signaled over multiple RTP packets, for example, if/when the total number of spatial regions is large and/or may not be accommodated into a single RTP packet, for example, due RTP header extension size limitations and/or RTP packet size limitations.

Dynamic spatial regions information may be sent in multiple RTP packets. The first, and last, RTP packets carrying the dynamic spatial regions information in an RTP header extension data may be identified using the ‘appbits’ values, for example, if/when the dynamic 3D regions feature is supported, and the dynamic spatial regions information is sent in multiple RTP packets.

Table 19 shows an example of an RTP header extension with a 16-bit value in a two-byte header form.

TABLE 19
Example of an RTP header extension with
a 16-bit value in a two-byte header form

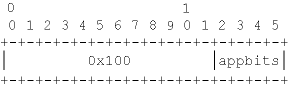

Table 20 shows an example of the ‘appbits’ in the RTP header extension for a sent 3D regions message, which may be indicated via the URN urn:dynamic-3d-regions-sent in the SDP negotiation.

TABLE 20
Example of the ‘appbits’ in the RTP header
extension for a sent 3D regions message

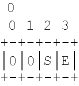

As shown by example in Table 20, S may be a bit set to one (1), for example, for the first RTP packet carrying dynamic 3D regions information. S may be set to zero (0), for example, if otherwise. E may be a bit set to one (1), for example, for the last RTP packet carrying the dynamic 3D regions information. E may be set to zero (0), for example, if otherwise.

Viewport-based partial access support may be provided, for example, using SDP signaling. A client (for example, a sender or a receiver) supporting streaming of immersive media content based on the user's viewport may offer a ‘Viewport-dependent streaming (VDS)’ capability in SDP for (for example, all) volumetric media content where viewport-based immersive media streaming is desired. VDS support may be offered, for example, by including an a=rtcp-fb attribute (for example, under a relevant media line scope). VDS support using the RTCP feedback method may be expressed, for example, with the following parameter: 3d-viewport. A wildcard payload type (“*”) may be used to indicate that the RTCP feedback attribute for VDS support signaling applies to (for example, all) payload types. Multiple (for example, several) “a=rtcp-fb” lines may be used, for example, if/when the same viewport may be specified for a subset of the payload types. An a=rtcp-fb attribute may be used to signal viewport-dependent streaming relative to a media line based on the RTCP feedback method, for example, as follows:

$$a = rtcp - fb {:}^{*} 3 d - viewport$$

A client supporting the use of viewport-dependent streaming may include the rtcp-fb: 3d-viewport attribute in the SDP offer and answer. The client supporting VDS may (for example, further) support an RTCP feedback (FB) message to carry requested viewport information during the RTP streaming of media (for example, signaled from the receiver to the sender).

A client may not include 3d-viewport attribute in the SDP answer, for example, if the 3d-viewport attribute is not available in the SDP offer.

Viewport-based partial access support may be provided, for example, using an RTCP feedback message for signaling a viewport.

Viewport-dependent streaming of immersive media content may be successfully negotiated between the sender and receiver as per the SDP-based negotiation procedures (for example, as described herein). An RTCP feedback (FB) message 3d-viewport may (for example, based on a successful negotiation) carry requested viewport information during the RTP transmission of immersive media signaled from the receiver to the sender.

The signaling of viewport requests may use RTCP feedback messages. An RTCP feedback message may be identified by payload a type (PT) (for example, a PT equal to 206) that corresponds to a payload-specific feedback (PSFB) message. The feedback message type (FMT) may be set to the value ‘X’ for viewport request feedback messages. The RTCP feedback method may involve signaling of viewport information in the immediate feedback and/or in early RTCP modes.

A feedback control information (FCI) format for a 3D viewport request message may be as follows. An FCI may include a (for example, exactly one) 3D viewport. Viewport information in an RTCP feedback viewport message may include, for example, one or more of the following parameters: cam_pos_x; cam_pos_y; cam_pos_z; cam_quat_x; cam_quat_y: cam_quat_z; camera_type; horizontal_fov; vertical_fov; clipping_near_plane; and/or clipping_far_plane.

Parameters cam_pos_x, cam_pos_y, and cam_pos_z may indicate, respectively, the x, y, and z coordinates of the position of the camera (for example, in meters) in the global reference coordinate system. The values may be expressed in 32-bit binary floating-point format, for example, with the 4 bytes in big-endian order. Parameters cam_pos_x, cam_pos_y, and cam_pos_z may be associated with a parsing process.

Parameters cam_quat_x, cam_quat_y, and cam_quat_z may indicate, respectively, the x, y, and z components of the rotation of the camera using a quaternion representation. The values may be in the range of −230 to 230, inclusive. The value of rotation may be inferred to be equal to zero (0), for example, if/when the component of rotation is not present. The value of rotation components may be calculated, for example, in accordance with Eq. (1)-(3):

$$qX = cam\_quat \_x \div {2}^{30} \qquad ( 1 )$$

$$qY = cam\_quat \_y \div {2}^{30} \qquad ( 2 )$$

$$qZ = cam\_quat \_z \div {2}^{30} \qquad ( 3 )$$

The fourth component, qW, for the rotation of the (for example, current) camera model using the quaternion representation may be calculated, for example, in accordance with Eq. (4):

$$q W = Sqrt ( 1 - \{ q X 2 + q Y 2 + q Z 2 ) ) \qquad ( 4 )$$

The point (w, x, y, z) may represent a rotation around the axis directed by the vector (x, y, z) by an angle, for example, in accordance with Eq. (5):

$$2 * cos \hat{} \{ - 1 \} ( w ) = 2 * sin \hat{} \{ - 1 \} ( sqrt \{ x \hat{} \{ 2 \} + y \hat{} \{ 2 \} + z \hat{} \{ 2 \} ) ) \qquad ( 5 )$$

Parameter camera_type may indicate the projection method of the viewport. An ERP projection may be specified, for example, by a value of zero (0). A perspective projection may be specified, for example, by a value of one (1). An orthographic projection may be specified, for example, by a value of two (2). Values in the range 3 to 255 may be reserved (for example, for future use).

Parameter horizontal_fov may indicate (for example, if/when camera_type is an ERP projection) the longitude range corresponding to the horizontal size of the viewport region (for example, in units of radians). The value may be in the range 0 to 2π. Parameter horizontal_fov may indicate (for example, if/when camera_type is a perspective projection) the horizontal field of view (for example, in radians). The value may be in the range of 0 to π. Parameter horizontal_fov may indicate (for example, if/when camera_type is an orthographic projection) the horizontal size of the orthogonal (for example, in meters). The value may be expressed in a 32-bit binary floating-point format, for example, with the four (4) bytes in big-endian order. Parameter horizontal_fov may be associated with a parsing process.

Parameter vertical_fov may indicate (for example, if/when camera_type is an ERP projection) the latitude range corresponding to the vertical size of the viewport region, for example, in units of radians. The value may be in the range 0 to π. Parameter vertical_fov may indicate (for example, if/when camera_type is a perspective projection) the relative aspect ratio of viewport for perspective projection (for example, horizontal/vertical). The value may be expressed in a 32-bit binary floating-point format, for example, with the four (4) bytes in big-endian order. Parameter vertical_fov may be associated with a parsing process. Parameter vertical_fov may indicate (for example, if/when camera_type is an orthographic projection) the relative aspect ratio of viewport for orthogonal projection (for example, horizontal/vertical). The value may be expressed in 32-bit binary floating-point format, for example, with the four (4) bytes in big-endian order. Parameter vertical_fov may be associated with a parsing process.

Parameters clipping_near_plane and clipping_far_plane may indicate, respectively, the near and far depths or distances based on the near and far clipping planes of the viewport (for example, in meters). The values may be expressed in a 32-bit binary floating-point format, for example, with the four (4) bytes in big-endian order. Parameters clipping_near_plane and clipping_far_plane may be associated with a parsing process.

An interested 3D viewport request RTCP feedback message may include, for example, one or more (for example, all) of the parameters: cam_pos_x, cam_pos_y, cam_pos_z, cam_quat_x, cam_quat_y, and/or cam_quat_z. The values for (for example, each of) the parameters may be indicated, for example, using four bytes.

Table 21 shows an example of an FCI for a 3D viewport request RTCP feedback message.

TABLE 21
Example of an FCl for a 3D viewport request RTCP feedback message

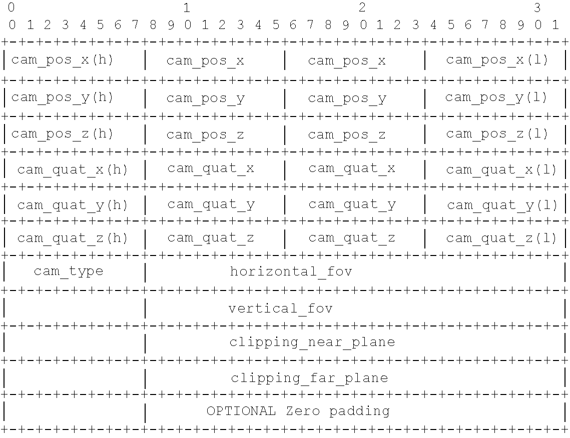

In examples, the RTCP viewport feedback message may include flag(s), for example, ext_camera_flag and/or int_camera_flag. The flags may indicate whether the extrinsic camera parameters (e.g., ext_camera_flag) and/or the intrinsic camera parameters (e.g., int_camera_flag) are present or not in the RTCP message. This message may include a flag, for example equal_fov_flag, that may indicate whether the horizontal and vertical FOVs are equal or not.

Table 22 shows an example of an FCI for a 3D viewport request RTCP feedback message (e.g., including ext_camera_flag, int_camera_flag, and equal_fov_flag).

TABLE 22
Example of an FCl for a 3D viewport request RTCP feedback message

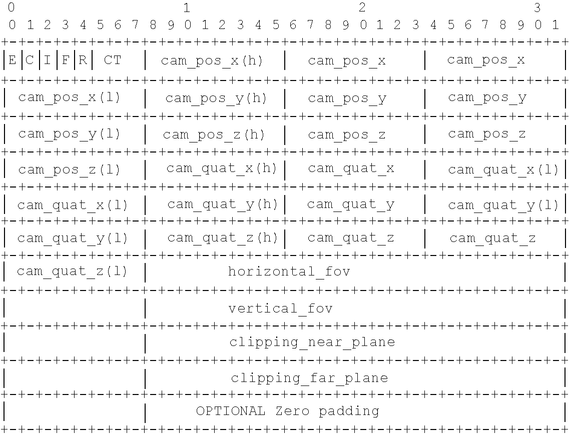

An RTCP feedback viewport message may include one or more of: whether extrinsic camera parameters information is present in the message (e.g., ext_camera_flag); whether the signaled viewport position corresponds to the center of the viewport (e.g., center_view_flag); whether intrinsic camera parameters information is present in the message (e.g., int_camera_flag); whether the horizontal FOV and the vertical FOV of the viewport are equal or not (e.g., equal_fov_flag); a reserved bit (e.g., resv); the projection method of the viewport (e.g., camera_type); x, y, and/or z coordinates of the position of the camera (e.g., cam_pos_x, cam_pos_y, and/or cam_pos_z); x, y, and/or z components of the rotation of the camera using the quaternion representation (e.g., cam_quat_x, cam_quat_y, and/or cam_quat_z); a longitude range corresponding to the horizontal size of the viewport region (e.g., horizontal_fov); a latitude range corresponding to the vertical size of the viewport region (e.g., vertical_fov); or the near and/or far depths or distances based on the near and far clipping planes of the viewport (e.g., clipping_near_plane and/or clipping_far_plane).

An RTCP feedback viewport message may indicate (e.g., include a flag to indicate) that extrinsic camera parameters information is present in the message (e.g., ext_camera_flag (E)). The flag may be 1 bit. A flag value equal to 1 may indicate that extrinsic camera parameters information is present in the message. A flag value equal to 0 may indicate that extrinsic camera parameters information is not present in the message.

An RTCP feedback viewport message may indicate (e.g., include a flag to indicate) whether the signaled viewport position corresponds to the center of the viewport or to one of two stereo positions of the viewport (e.g., center_view_flag (C). The flag may be 1 bit. A flag value equal to 1 may indicate that the signaled viewport position corresponds to the center of the viewport. A flag value equal to 0 may indicate that the signaled viewport position corresponds to one of two stereo positions of the viewport. In examples, when an extrinsic camera parameters flag (e.g., ext_camera_flag) is set to value 0, a center viewport position flag (e.g., center_view_flag) value may be set to 0 (e.g., the center viewport position flag may otherwise be set to 1).

An RTCP feedback viewport message may indicate (e.g., include a flag to indicate) that intrinsic camera parameters information is present in the message (e.g., int_camera_flag (I)). The flag may be 1 bit. A flag value equal to 1 may indicate that intrinsic camera parameters information is present in the message. A flag value equal to 0 may indicate that intrinsic camera parameters information is not present in the message.

An RTCP feedback viewport message may indicate (e.g., include a flag to indicate) whether the horizontal FOV and the vertical FOV of the viewport are equal or not (e.g., equal_fov_flag (F). The flag may be 1 bit. A flag value equal to 1 may indicate the horizontal FOV and the vertical FOV are equal. A flag value equal to 0 may indicate the horizontal FOV and the vertical FOV are not equal. In examples, when intrinsic camera parameters information is not present in the message (e.g., int_camera_flag value is 0), the equal FOV flag may be set to 1 (e.g., the equal FOV flag may otherwise be set to 1).

An RTCP feedback viewport message may include a reserved bit (e.g., resv (R)) for future definition.

An RTCP feedback viewport message may indicate a projection method of the viewport (e.g., camera_type (CT). The projection method may be indicated in 3 bits. An indication of the projection method of the viewport may specify one or more of: an equirectangular projection (ERP); a perspective projection; or an orthographic projection. For example, a value of 0 may specify ERP, a value of 1 may specify a perspective projection, and/or a value of 2 may specify an orthographic projection. In examples, other values (e.g., values in the range 3 to 7) may be reserved for future use.

An RTCP feedback viewport message may indicate the x, y, and/or z coordinates of the position of the camera (e.g., cam_pos_x, cam_pos_y, and/or cam_pos_z respectively). The x, y, and/or z coordinates of the position of the camera may be indicated in the global reference coordinate system (e.g., in meters). The values may be expressed in 32-bit binary floating-point format with the 4 bytes in big-endian order and with a specified parsing process. The x, y, and/or z coordinates of the position of the camera may be present in the RTCP feedback viewport message if/when the signaled viewport position corresponds to the center of the viewport (e.g., ext_camera_flag (E bit) is set to 1).

An RTCP feedback viewport message may indicate the x, y, and/or z components of the rotation of the camera using the quaternion representation (e.g., cam_quat_x, cam_quat_y, and/or cam_quat_z respectively). The values may be in the range of −230 to 230, inclusive. When the component of rotation is not present, its value may be inferred to be equal to 0. In examples, the x, y, and/or z components of the rotation of the camera using the quaternion representation may be present (e.g., may only be present) if/when the signaled viewport position corresponds to the center of the viewport (e.g., ext_camera_flag (E bit) is set to 1). The value of rotation components may be calculated as follows:

$$q X = cam\_quat \_x \div {2}^{30} , qY = cam\_quat \_y \div {2}^{30} , qZ = cam\_quat \_z \div {2}^{30}$$

A fourth component, qW, for the rotation of the current camera model using the quaternion representation and may be calculated as follows:

$$qW = Sqrt ( 1 - ( {qX}^{2} + {qY}^{2} + {qZ}^{2} ) )$$

The point (w, x, y, z) may represent a rotation around the axis directed by the vector (x, y, z) by an angle:

$$2 * cos \hat{} \{ - 1 \} ( w ) = 2 * sin \hat{} \{ - 1 \} ( sqrt \{ x \hat{} \{ 2 \} + y \hat{} \{ 2 \} + z \hat{} \{ 2 \} ) ) .$$

An RTCP feedback viewport message may indicate the longitude range corresponding to the horizontal size of the viewport region (e.g., horizontal_fov). horizontal_fov may be 32 bits. If/when camera_type is an ERP projection, the value may be expressed in units of radians and/or may be in the range 0 to 2π. If/when camera_type is a perspective projection, the value may specify the horizontal field of view in radians) and/or may be in the range of 0 and π. When camera_type is an orthographic projection, the value may specify the horizontal size of the orthogonal in meters and/or may be expressed in 32-bit binary floating-point format (e.g., with the 4 bytes in big-endian order and with a specified parsing process). This information may be present (e.g., may only be present) when intrinsic camera parameters information is present in the message (e.g., the int_camera_flag (I bit) is set to 1).

An RTCP feedback viewport message may indicate a latitude range corresponding to the vertical size of the viewport region (e.g., vertical_fov). vertical_fov may be 32 bits. If/when camera_type is an ERP projection, the value may be expressed in units of radians and/or be in the range 0 to π. If/when camera_type is a perspective projection, this value may specify the relative aspect ratio of viewport for perspective projection (e.g., horizontal/vertical) and/or may be expressed in 32-bit binary floating-point format (e.g., with the 4 bytes in big-endian order and with a specified parsing process). When camera_type is an orthographic projection, this value may specify the relative aspect ratio of viewport for orthogonal projection (e.g., horizontal/vertical) and/or may be expressed in 32-bit binary floating-point format (e.g., with the 4 bytes in big-endian order and with a specified parsing process). This information may be present (e.g., may only be present) when intrinsic camera parameters information is present in the message (e.g., the int_camera_flag (I bit) is set to 1) and when the horizontal FOV and the vertical FOV are not equal (e.g., the equal_fov_flag (F) is set to 0). In examples, vertical FOV information may not be present.

An RTCP feedback viewport message may indicate the near and far depths (or distances) (e.g., in meters) based on the near and far clipping planes of the viewport (e.g., clipping_near_plane and clipping_far_plane). This value may be 32 bits. The values may be expressed in 32-bit binary floating-point format (e.g., with the 4 bytes in big-endian order and with a specified parsing process). This information may be present (e.g., may only be present) when intrinsic camera parameters information is present in the message (e.g., the int_camera_flag (I bit) is set to 1).

Viewport-based partial access support may include an RTP header extension for a sent viewport notification. An RTCP feedback message for an interested 3D viewport may be received by a sender from a receiver. The sender may (for example, based on the received message) respond to the receiver with one or more 3D spatial regions immersive media content that includes the requested 3D viewport. The sent 3d-region(s) may correspond to the static 3D regions, which may be indicated via the URN urn:static-3d-regions-sent in the SDP negotiation. The signaling of the sent 3D regions may use the RTP header extension. The signaling may carry the num_regions and region_id parameters corresponding to the sent static 3D region(s). The format of the RTP header extension for the sent 3D regions may be, for example, as described herein.

Viewport- and/or region-of-interest-dependent delivery of V3C data using RTP may be applied, for example, in ecosystems involving immersive media coding, real-time streaming of the coded immersive media content, decoding of immersive media on devices, and/or services that may provide low latency streaming of immersive media content and/or real-time communication.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-19. (canceled)

20. A device comprising:
a processor configured to:
receive a set of session description protocol (SDP) parameters indicating presence of one or more three-dimensional (3D) regions associated with immersive media content;
send a real-time control protocol (RTCP) feedback (FB) message, wherein the RTCP FB message indicates a 3D region of interest based on at least three origin position coordinates and at least three dimensions of the 3D region of interest; and
receive one or more 3D regions of visual volumetric video-based coding (V3C) content associated with the 3D region of interest.

21. The device of claim 20, wherein the at least three origin position coordinates comprise:
a first origin position coordinate of the 3D region of interest comprising an x-axis coordinate of an origin point;
a second origin position coordinate of the 3D region of interest comprising a y-axis coordinate of the origin point; and
a third origin position coordinate of the 3D region of interest comprising a z-axis coordinate of the origin point.

22. The device of claim 20 or 21, wherein the at least three dimensions of the 3D region of interest comprise:
a first dimension of the 3D region of interest comprising an extension of the 3D region of interest along the x-axis relative to an origin point;
a second dimension of the 3D region of interest comprising an extension of the 3D region of interest along the y-axis relative to the origin point; and
a third dimension of the 3D region of interest comprising an extension of the 3D region of interest along the z-axis relative to the origin point.

23. The device of claim 20, wherein the processor is further configured to:
perform capability negotiations, wherein the capability negotiations are performed using SDP, and wherein the set of SDP parameters is received during capability negotiations.

24. The device of claim 20, wherein the processor is further configured to:
receive an SDP message indicating use of a real time protocol (RTP) header extension, wherein the received one or more 3D regions of V3C content are received using the RTP header extension.

25. The device of claim 24, wherein the RTCP FB message is sent using an RTCP message, and wherein the RTCP FB message includes an indication of a region ID associated with the 3D region of interest.

26. The device of claim 20, wherein the 3D region of interest is a static 3D region or an arbitrary 3D region.

27. A device comprising a processor configured to:
receive a set of session description protocol (SDP) parameters indicating presence of one or more three-dimensional (3D) regions associated with an immersive media content;
send a real-time control protocol (RTCP) feedback (FB) message, wherein the RTCP FB message indicates a 3D viewport of interest based on at least three camera position coordinates and at least three rotation values associated with the 3D viewport of interest; and
receive one or more 3D regions of visual volumetric video-based coding (V3C) content associated with the 3D viewport of interest.

28. The device of claim 27, wherein the at least three camera position coordinates comprise:
a first camera position coordinate of the 3D viewport of interest comprising an x-axis coordinate of a camera in a global reference coordinate system;
a second camera position coordinate of the 3D viewport of interest comprising a y-axis coordinate of the camera in the global reference coordinate system; and
a third camera position coordinate of the 3D viewport of interest comprising a z-axis coordinate of the camera in the global reference coordinate system.

29. The device of claim 27 or 28, wherein the at least three rotation values comprise:
an x-axis component of a quaternion representation of rotation of a camera associated with the 3D viewport of interest;
a y-axis component of the quaternion representation of rotation of the camera; and
a z-axis component of the quaternion representation of rotation of the camera.

30. The device of claim 27, wherein the processor is further configured to:
perform capability negotiations, wherein the capability negotiations are performed using SDP, and wherein the set of SDP parameters is received during capability negotiations.

31. The device of claim 27, wherein the processor is further configured to:
receive an SDP message indicating use of a real time protocol (RTP) header extension, wherein the received one or more 3D regions of V3C content are received using the RTP header extension.

32. The device of claim 27, wherein the RTCP FB message is sent using an RTCP message, and wherein the RTCP FB message further indicates whether extrinsic camera parameters associated with the 3D viewport of interest are present in the RTCP message.

33. The device of claim 27, wherein the RTCP FB message is sent using an RTCP message, and wherein the RTCP FB message further indicates whether intrinsic camera parameters associated with the 3D viewport of interest are present in the RTCP message.

34. The device of claim 33, wherein the RTCP FB message further indicates whether a horizontal FOV associated with the 3D viewport of interest and a vertical FOV associated with the 3D viewport of interest are equal.

35. A method comprising:
receiving a set of session description protocol (SDP) parameters indicating presence of one or more three-dimensional (3D) regions associated with immersive media content;
sending a real-time control protocol (RTCP) feedback (FB) message, wherein the RTCP FB message indicates a 3D region of interest based on at least three origin position coordinates and at least three dimensions of the 3D region of interest; and
receiving one or more 3D regions of visual volumetric video-based coding (V3C) content associated with the 3D region of interest.

36. The method of claim 35, wherein the at least three origin position coordinates comprise:
a first origin position coordinate of the 3D region of interest comprising an x-axis coordinate of an origin point;
a second origin position coordinate of the 3D region of interest comprising a y-axis coordinate of the origin point; and
a third origin position coordinate of the 3D region of interest comprising a z-axis coordinate of the origin point.

37. The method of claim 35 or 36, wherein the at least three dimensions of the 3D region of interest comprise:
a first dimension of the 3D region of interest comprising an extension of the 3D region of interest along the x-axis relative to an origin point;
a second dimension of the 3D region of interest comprising an extension of the 3D region of interest along the y-axis relative to the origin point; and
a third dimension of the 3D region of interest comprising an extension of the 3D region of interest along the z-axis relative to the origin point.

38. The method of claim 35, wherein the method further comprises:
performing capability negotiations, wherein the capability negotiations are performed using SDP, and wherein the set of SDP parameters is received during capability negotiations.

39. The method of claim 35, wherein the method further comprises:
receive an SDP message indicating use of a real time protocol (RTP) header extension, wherein the received one or more 3D regions of V3C content are received using the RTP header extension.
